(19) United States
(12) Patent Application Publication
(10) Pub. No.: US 2018/0346153 A1
(43) Pub. Date: Dec. 6, 2018

(54) Apparatus and Methods for Orbital Sensing and Debris Removal

(71) Applicant: Launchspace Technologies Corporation, Wilmington, DE (US)

(72) Inventor: Marshall H. Kaplan, Bethesda, MD (US)

(21) Appl. No.: 15/949,589

(22) Filed: Apr. 10, 2018

Related U.S. Application Data
(60) Provisional application No. 62/512,488, filed on May 30, 2017.

(51) Int. Cl. B64G 1/24; B64G 3/00; B64G 1/10; B64G 1/56

(52) U.S. Cl. CPC B64G 1/242; B64G 1/56; B64G 1/1085; B64G 3/00

(57) ABSTRACT

Space traffic is managed using data gathered by orbital sensors. A constellation of near-equatorial orbiting satellites can be established, with each satellite in the constellation including at least one sensor for tracking resident space objects (“RSO”). The tracking data gathered by these orbital sensors can be fused with previously-gathered orbital tracking data and/or tracking data from ground-based sensors and used to adjust orbital information for the RSOs. The adjusted orbital information for the RSOs can, in turn, be used to issue conjunction warnings, to adjust the orbits of one or more satellites in the constellation (e.g., to intercept a debris object; to intercept a target; to avoid an active spacecraft), and/or to adjust the orbits of one or more other spacecraft (e.g., to avoid debris).

### CROSS-REFERENCE TO RELATED APPLICATIONS

This application claims the benefit of U.S. provisional application No. 62/512,488, filed 30 May 2017 (“the '488 application”).

This application is also related to U.S. application Ser. No. 15/448,074, filed 2 Mar. 2017 (“the '074 application”), now U.S. Pat. No. 9,714,101, which is a continuation-in-part of U.S. application Ser. No. 15/352,185, filed 15 Nov. 2016 (“the '185 application”), now U.S. Pat. No. 9,617,017, which is a continuation of U.S. application Ser. No. 15/333,268, filed 25 Oct. 2016 (“the '268 application”), now abandoned.

The '488, '074, '185, and '268 applications are hereby incorporated by reference in their entireties as though fully set forth herein.

### BACKGROUND

The instant disclosure relates generally to the removal and control of orbital debris. In particular, the instant disclosure relates to apparatus and methods for removing orbital debris from low Earth orbit (“LEO”).

The term “resident space object” (“RSO”) refers to natural and artificial objects that orbit another object, such as operational satellites and other spacecraft. RSOs that no longer serve any function are called “orbital debris” (the term “debris” is used herein as a shorthand to refer to orbital debris). Examples of orbital debris include expired spacecraft, upper stages of launch vehicles, debris released during separation of a spacecraft from its launch vehicle or during mission operations, debris created as a result of spacecraft or upper stage explosions or collisions, solid rocket motor effluents, paint flecks, and thermal blankets.

Orbital debris threatens operational satellites, particularly in LEO, and more particularly between about 600 km and about 1200 km altitude. In fact, most debris objects travel in circular or near-circular orbits at altitudes between about 600 km and about 1,200 km, where they threaten operating scientific, commercial, and military satellites.

The orbital debris threat generally falls into one of three categories, based on the size of the debris. Debris larger than about 10 cm in size can cause catastrophic damage to an operational satellite or other spacecraft. Debris between about 1 mm and about 10 cm in size can cause lesser, but nonetheless significant, damage to an operational satellite or other spacecraft. Still smaller debris (e.g., less than about 1 mm in size) can cause sandpapering effects.

Collision warnings and alerts (e.g., between an active satellite and a piece of large debris) are already numerous, and the frequency and severity of impacts and near-collisions will likely increase over the next several years due to the expected launch of over 10,000 new satellites. Some hypotheses hold that, if the accumulation of orbital debris is not checked, the LEO debris field will increase in density until space flight is effectively impossible to accomplish safely.

Currently, ground-based sensors are the primary source of space situational awareness (“SSA”) and traffic management data used to generate collision warnings and alerts (collectively, “conjunction warnings”). For example, orbital debris detection and tracking is typically accomplished using ground-based sensors. Yet, these ground-based assets (e.g., facilities and personnel) are limited and expensive. Consequently, debris detection and tracking activities have been intermittent and subject to lower levels of accuracy.

Moreover, it is difficult for extant ground-based sensors to detect and track smaller debris (e.g., less than about 10 cm in size). This limits the ability to generate conjunction warnings between active satellites and smaller debris, despite the harm that smaller debris can nonetheless inflict thereupon.

At the other end of the spectrum are large debris objects (e.g., about 10 cm or greater in size), which ground-based sensors can more readily track. Although large debris can do substantial, and even catastrophic, damage to an active satellite, large debris objects are far fewer in number than the smaller debris objects discussed above, with an estimated population of about 25,000 debris objects. Because of the vastness of space, the frequency of collisions between large debris objects and active satellites is extremely low, with the probability of such collisions approaching zero. For instance, there is only one confirmed instance of a collision between an expired satellite (Cosmos 2251) and an active satellite (Iridium 33).

Nonetheless, a substantial number of conjunction warnings are issued to satellite operators daily. These warnings are, however, susceptible to various shortcomings, including trajectory prediction errors, tracking errors, and delays. In fact, the collision between Cosmos 2251 and Iridium 33 was only detected after-the-fact.

### BRIEF SUMMARY

It would be desirable to perform at least the foregoing functions (e.g., orbital debris removal, orbital debris tracking, and the like) using one or more LEO satellites in the equatorial, or a near-equatorial, plane. For purposes of this disclosure, the term “near-equatorial plane” means from the equatorial plane up to about 28.5 degrees inclination relative to the equatorial plane.

Indeed, the use of LEO satellites may allow these functions to be performed more thoroughly and precisely than the use of ground-based sensors. For instance, the use of sensors in LEO in the equatorial or a near-equatorial plane can assist in tracking smaller debris objects (e.g., less than about 10 cm in size).

Another advantage is that orbiting sensors are not limited by geography or politics.

Disclosed herein is a method of managing space traffic, including communicating with a satellite constellation including a plurality of satellites, each satellite being in a near-equatorial, low Earth orbit and comprising at least one sensor for tracking resident space objects (“RSO”), wherein communicating with the satellite constellation further includes: receiving, from the satellite constellation, tracking data for a plurality of RSOs; and using the tracking data received from the satellite constellation to adjust orbital trajectory information for the plurality of RSOs.

The method can also include integrating the tracking data received from the satellite constellation with an RSO catalog. In embodiments of the disclosure, the RSO catalog can include RSO tracking data received from a terrestrial sensor.

According to aspects of the disclosure, the method also includes issuing a conjunction warning between an RSO of the plurality of RSOs and a space vehicle based upon the adjusted orbital trajectory information for the plurality of RSOs.

The step of communicating with the satellite constellation can also include adjusting an orbit of at least one satellite responsive to the adjusted orbital trajectory information for the plurality of RSOs. In embodiments, the at least one satellite can include at least one debris interception vehicle, and the step of adjusting an orbit of the at least one satellite responsive to the adjusted orbital trajectory information for the plurality of RSOs can include commanding the at least one debris interception vehicle to maneuver into position to intercept a target RSO of the plurality of RSOs.

It is contemplated that at least some satellites of the plurality of satellites include at least one debris impact pad.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 illustrates two representative orbits that can be utilized by multi-functional spacecraft according to the teachings herein.

FIG. 2 illustrates a multi-functional spacecraft for debris removal and impact data collection according to aspects of the instant disclosure.

FIG. 3 illustrates the central body of the multi-functional spacecraft of FIG. 2, showing various subsystems thereof.

FIG. 4 is a diagram that illustrates data collection, processing, and debris field modelling according to aspects disclosed herein.

FIG. 5 is a representative logic flow diagram of a software algorithm that can be used in modelling and controlling a multi-functional spacecraft according to aspects of the instant disclosure to remove smaller debris objects while avoiding larger debris objects.

FIG. 6 illustrates an exemplary “tuned” orbit, slightly elliptical in shape in order to optimize its effectiveness in encountering debris objects, according to aspects of the instant disclosure.

### DETAILED DESCRIPTION

The instant disclosure provides one or more constellations of satellites in equatorial (or near-equatorial) orbit that incorporate both debris sensing/tracking capabilities and debris removal capabilities. Embodiments of the disclosure are described herein with reference to a satellite constellation that includes multi-function satellites configured to sense, track, and remove debris. That is, according to the exemplary embodiments discussed herein, satellites in the constellation are equipped both with sensor array(s) for RSO detection, tracking enhancement, and increased trajectory modelling precision, and with a debris collection mechanism, such as a debris impact pad.

It should be understood, however, that the teachings herein can also be applied in other contexts. For example, it is contemplated that a first satellite constellation can include exclusively sensing/tracking satellites, while a second satellite constellation can include exclusively debris removal satellites.

Advantageously, this disclosure includes methods, apparatus, and systems that facilitate the avoidance of active operating satellites within the debris zone, while eliminating debris objects. Another advantage of the instant disclosure is that it minimizes the need for significant out-of-plane maneuvers. Still another advantage of the instant disclosure is that it is unlikely to appear to be a space weapon. As a result, the teachings herein include systems and methods that are cost-effective and acceptable to the international space community.

Satellites in a constellation according to aspects of the instant disclosure may be assigned responsibility for specified debris object size ranges, beginning, for example, with debris objects of about 1 mm in size. Debris collection mechanisms can be sized to eliminate debris objects up to about a few meters in size.

Debris elimination operations as disclosed herein occur in or near the Earth's equatorial plane. This leverages that low-orbiting debris and active satellites tend to be less dense at the equator and denser at high latitudes, and that every piece of non-equatorial debris must pass through the plane of the Earth's equator twice per orbit, once from north-to-south and once from south-to-north.

This disclosure facilitates the creation of effective space traffic management operations, safe LEOs for satellites and constellations, and complete SSA information. These objectives are desirable for continued access to near-Earth space applications and can be achieved through the use of in-orbit RSO sensors, software for modelling and optimization of debris collection orbits, data fusion, “tuned” equatorial orbits, and debris impact pads.

Heretofore unknown to those of ordinary skill in the art is the use of spacecraft that use an impact pad for wholesale debris collection while in equatorial orbits. In addition, for the first time, sensors that look directionally (e.g., north and south) are mounted on equatorial spacecraft in order to collect data on RSOs, such as detection and tracking information. This in-orbit RSO data is then combined with terrestrial RSO data in order to generate significantly improved knowledge of the LEO debris field, to predict with greater accuracy close encounters between active satellites and debris, and to expand RSO catalogs for space traffic management operations.

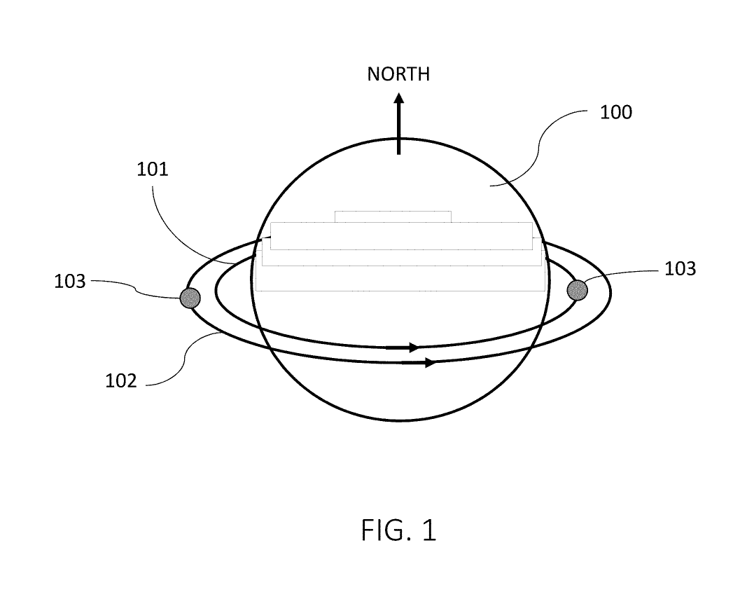

FIG. 1 depicts the Earth 100 and two exemplary LEOs 101, 102 in the equatorial plane. Although a full constellation may contain many satellites, only two satellites 103 are illustrated in FIG. 1. Each of the two orbits 101, 102 contains one satellite 103. The exact shape of each orbit 101, 102 (e.g., circular, elliptical) can be selected according to the teachings herein to maximize the debris collection rate while avoiding RSOs (including debris) larger than a pre-determined size. It is also contemplated that orbits 101, 102 can be selected to intercept certain RSOs (including active spacecraft) of particular interest (e.g., for national security reasons or because an RSO presents special concern to constellation operators). More specifically, orbits 101, 102 can be designed, according to the teachings herein, to focus on the removal of debris objects that pose an imminent threat to an operating satellite or constellation of operating satellites.

Satellites 103 can be designed to operate in the zones of maximum debris density, e.g., at altitudes between about 600 km and about 1,200 km. The aspects of this disclosure can, of course, be applied to a wider range of altitudes, but debris densities tend to be lower below about 600 km and above about 1,200 km.

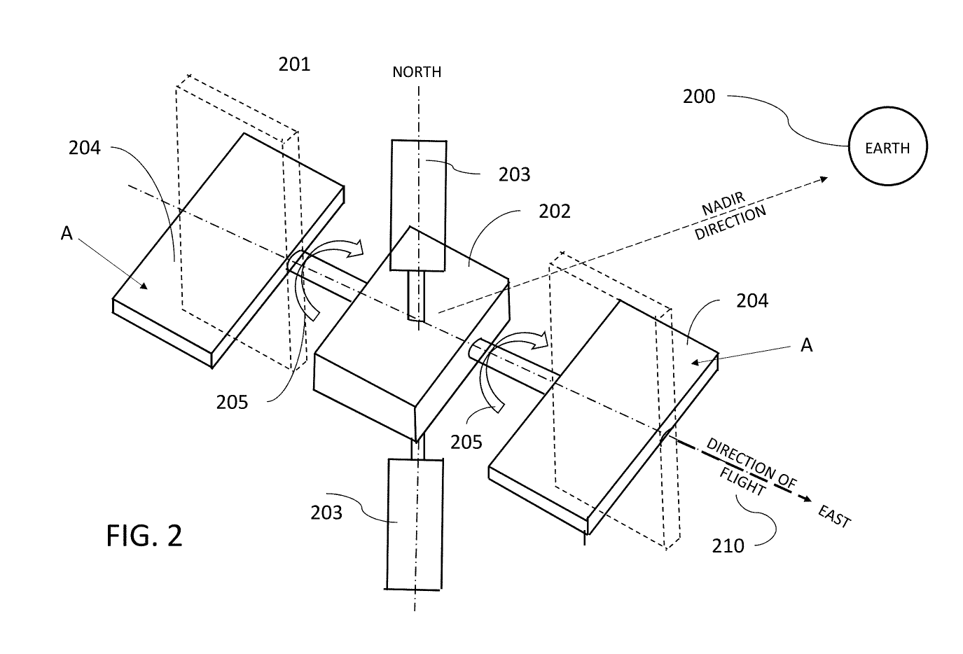

In embodiments, satellites 103 are multi-function vehicles configured for both RSO sensing and debris removal. FIG. 2 illustrates a representative multi-function space vehicle 201. Vehicle 201 generally includes at least one bus 202, one or more solar arrays 203, and at least one impact pad 204. As shown in FIG. 2, the velocity vector 210 is in the equatorial plane and directed east.

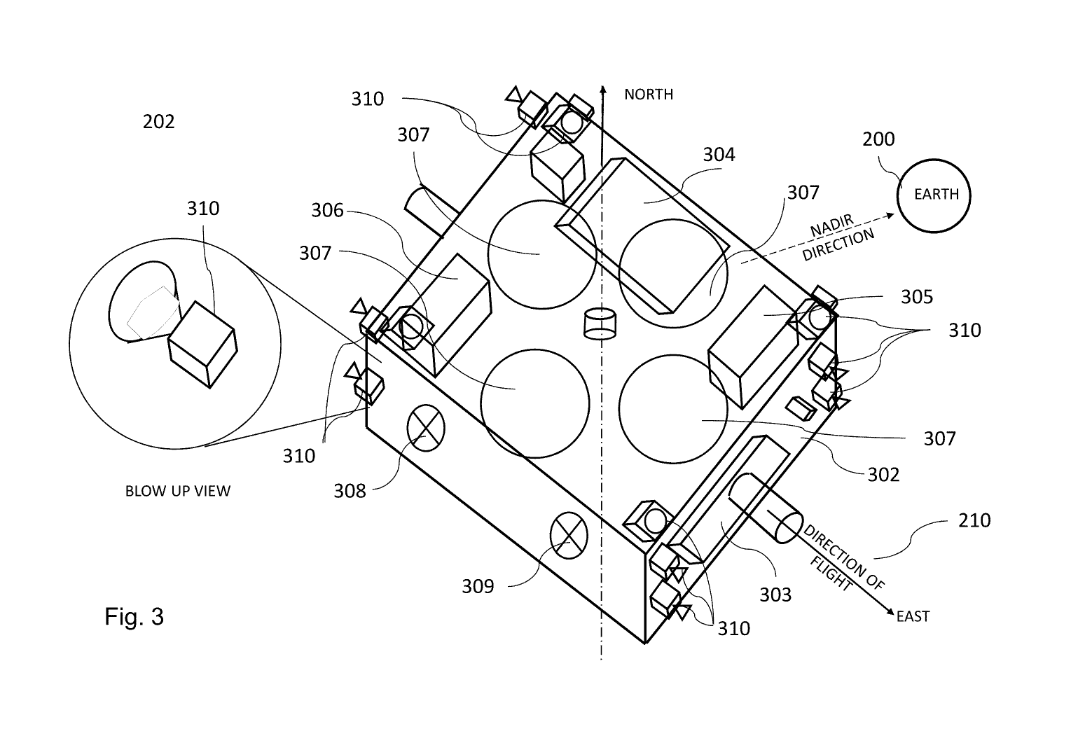

FIG. 3 illustrates aspects of bus 202. Velocity vector 210 and the north-south line are shown for reference. For the sake of illustration, bus 202 is represented schematically as a box design, though the ordinarily skilled artisan will appreciate that bus 202 can take other forms without departing from the scope of the instant disclosure. In general, bus 202 holds vehicle 201 together and contains subsystems for, inter alia, operating vehicle 201.

For instance, telemetry and command equipment 303 allows data and commands to travel via radio frequency (RF) techniques between vehicle 201 and ground station(s). As will be familiar to those of ordinary skill in the art, telemetry and command equipment 303 can include transmitters, receives, antennas, and signal processing equipment.

Bus 202 can also include one or more sensor arrays 304 for detecting and tracking RSOs. Each sensor array 304 can include one or more sensors (e.g., sensors designed to detect RSOs of various and varying size; sensors designed to detect RSOs at various and varying altitudes, up to the geosynchronous altitude and beyond), with the different sensor arrays 304 (and/or the sensors therein) offering different fields of view and orientations.

As discussed in further detail below, data collected by sensor arrays 304 can be sent (e.g., using telemetry and command equipment 303) to terrestrial facilities, where the data can be combined with other data (e.g., data gathered by terrestrial sensors) to produce precision RSO catalogs, accurate debris field density distributions, and precise collision avoidance solutions for satellite operators. Sensor arrays 304 also facilitate improved vehicle operational records and health monitoring.

Insofar as vehicle 201 will spend about half of its time in Earth's shadow, bus 202 can also include one or more batteries 305, 306, which provide power during shadow periods. Solar arrays 203, shown in FIG. 2, can recharge batteries 305, 306 when vehicle 201 is in sunlight.

Vehicle 201 can also include a propulsion system to enable it to maneuver in orbit. Multiple propellant tanks 307 can be provided in order to maintain balance and sufficient propellant for maneuvers; FIG. 3 illustrates four tanks 307, but the number of tanks 307 may vary in other embodiments without departing from the scope of the disclosure. FIG. 3 also illustrates sixteen thrusters 310, four on each of the northerly, southerly, easterly, and westerly faces of bus 202. Of course, more or fewer thrusters 310 can be used without departing from the scope of the instant teachings; likewise, the configuration of thrusters 310 can be varied without departing from the scope of the instant teachings.

Bus 202 can also include refueling ports 308, 309, which allow vehicle 201 to be serviced (e.g., refilling propellant tanks 307) periodically by servicing units (not shown).

Thus, FIG. 3 depicts a representative bus 202 according to embodiments of the disclosure. Yet, it is contemplated that not every bus 202 will be identical. For example, vehicles 201 may contain various and varying additional payloads or sensor suites, e.g., for detecting and tracking RSOs of various and varying size. Likewise, FIG. 3 does not illustrate power processing, guidance, navigation, and control (“GN&C”), and attitude sensors, although these sensors, which will be familiar to those of ordinary skill in the art, can also be incorporated into bus 202.

Referring again to FIG. 2, vehicle 201 can include one or more impact (or debris collection) pads 204. Impact pads 204 may vary from vehicle to vehicle in order to deal with distinct sizes and types of RSOs, and those of ordinary skill in the art will be familiar with many suitable forms for impact pads 204 (e.g., Whipple shields). Impact pads 204 are attached to bus 202, such as by a rotating shaft, but can be detached therefrom for servicing and/or disposal when expended. Expended impact pads 204 can be replaced through the use of a servicing vehicle or tender.

Insofar as most debris approaching impact pads 204 will be approaching from either the north or south, impact pads 204 can be rotatable 205 about an axis. When impact pads 204 are oriented as shown in FIG. 2, their maximum cross-sectional area A faces north and south, which facilitates the interception of RSOs as they cross the equator. On the other hand, impact pads 204 can also be rotated 205 such that their maximum cross-sectional area A faces in the nadir and anti-nadir directions, which minimizes the likelihood of intercepting RSOs as they cross the equator; this configuration of impact pads 204 is shown in phantom in FIG. 2. Rotation 205 of impact pads 204 may be employed, for example, to avoid intersecting an RSO that is not a target for collection, such as an active satellite

As shown in FIG. 2, solar arrays 203 are oriented such that their axis of rotation is aligned with the north-south direction in order to assure maximum solar exposure with a single axis of rotation around the north-south direction. Solar arrays 203 can be permanently attached to bus 202 via a rotating shaft.

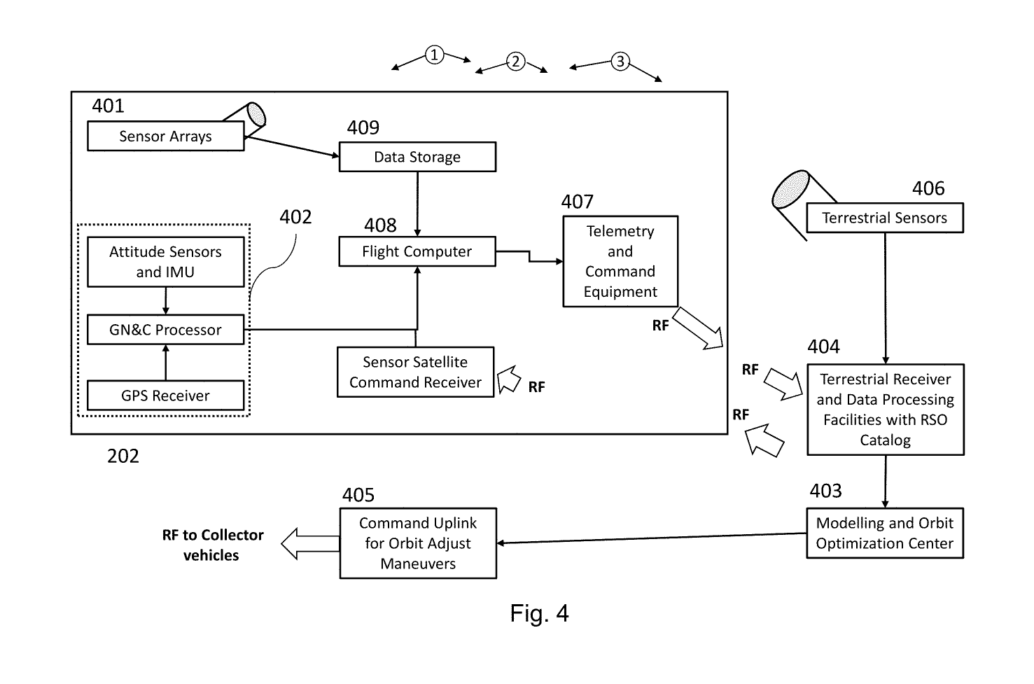

FIG. 4 is a block diagram that illustrates the collection of sensor data onboard vehicles 201 (e.g., using sensor arrays 304), the fusion of such sensor data with terrestrially-collected data, and processing (block 403) the fused data to produce enhanced information concerning debris population patterns, enhanced SSA, and viable space traffic management operations.

In block 401, in-orbit sensors (e.g., sensor arrays 304) scan altitudes where there are RSOs of interest and/or that may pose threats to active spacecraft (labeled “1,” “2,” and “3”). Depending on various factors, such as size and distance, RSOs may be detected, identified, and/or tracked. For example, smaller objects (e.g., less than about 1 mm in size) may only be detected, but not identified or tracked; medium-sized objects (e.g., between about 1 mm and about 10 cm in size) may be detected and identified, but not tracked; and larger objects (e.g., greater than about 10 cm in size) may be detected, identified, and tracked. Sensors 401 can store collected data in on-board data storage 409.

In block 408, a flight computer integrates the data collected by sensors 401 with data about the position and orientation of vehicle 201, which can be provided by in-orbit GN&C sensors 402. This integrated data can then be passed to telemetry and command equipment (e.g., 303) in block 407 for transmission (e.g., via RF) to a terrestrial receiver in block 404.

Terrestrial sensors 406 can also detect, identify, and track RSOs, though with limited capability relative to in-orbit sensor arrays 304. Terrestrial RSO information can exist in the form of an RSO catalog. Data from terrestrial sensors 406 can also be passed to terrestrial receiver 404, where it can be integrated with the data from in-orbit sensor arrays 304 (e.g., to update the RSO catalog with adjusted trajectory information for one or more RSOs).

The integrated RSO data can then be passed to a modeling and orbit optimization center in block 403, which can generate maneuver commands for vehicles 201. Maneuver commands can include, for example, commands that position impact pads 204 of a vehicle 201 in the pathway of an RSO to be intercepted (e.g., an orbital debris object) and commands that move vehicle 201 out of the pathway of an RSO that is not to be intercepted (e.g., an active satellite).

The maneuver commands generated in block 403 can be the result of ongoing simulations of potential mission solutions that allow optimization of propellant usage and satisfaction of debris control objectives. For example, objectives may include the delivery of cost-effective debris protection for a paying client while avoiding assisting non-payers (e.g., delivering debris collection services to customers while avoiding incidentally benefiting non-customers). Ongoing simulation may incorporate Monte Carlo methods to improve statistical verification of planned maneuvers. The resultant commands can be sent to a command uplink in block 405 for transmission to vehicles 201.

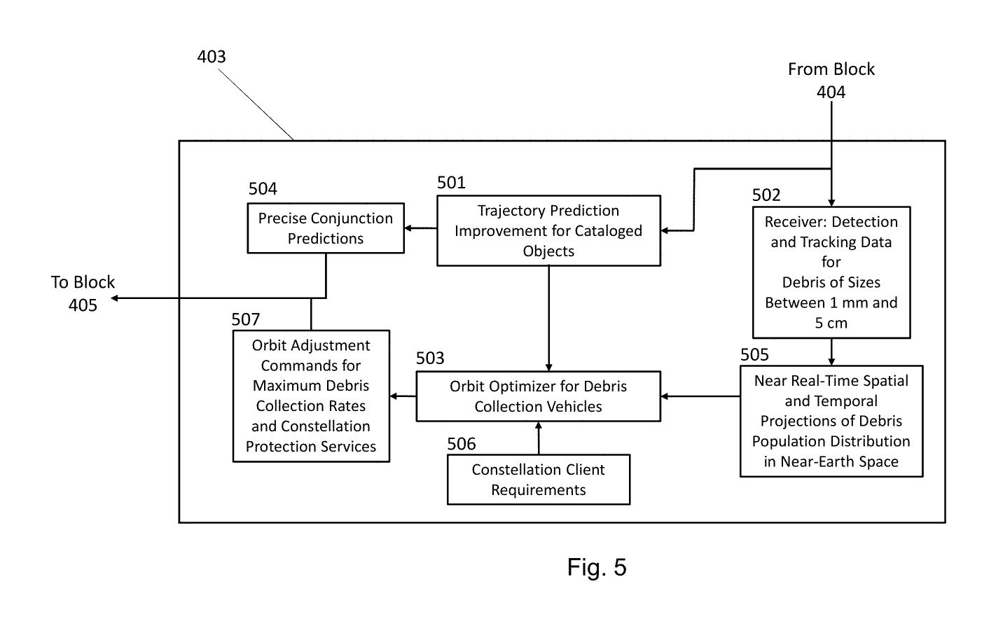

FIG. 5 illustrates an embodiment of a software algorithm that can be executed by the modeling and orbit optimization center in block 403 according to aspects of the instant disclosure. As shown in the upper right hand corner of FIG. 5, input to block 403 comes from terrestrial receiver 404, which integrates RSO data from both in-orbit sensor arrays 304 and terrestrial sensors (block 406). This input is received in both trajectory prediction improvement block 501 and detection and tracking data receiver block 502.

Trajectory prediction improvement block 501 computes and outputs conjunction predictions (block 504). Detection and tracking data receiver block 502 generates near real-time spatial and temporal small debris population distributions for LEO (block 505), which can be used, for example, in block 503, and in conjunction with both improved RSO trajectories (block 501) and client requirements (block 506) to optimize debris interception vehicle orbit(s) and to generate corresponding orbit adjustment commands in block 507. Commands are then passed to uplink 405.

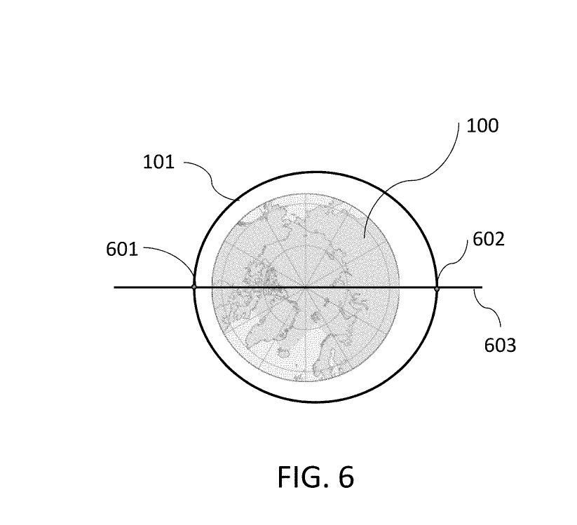

FIG. 6 illustrates orbital parameters determined by the software used in the modeling and orbit optimization center 403. The instant disclosure enables efficient debris collection by using “tuned” circular and non-circular orbits, a technique that has not been used before. The term “tuned,” as used herein, means that each orbital shape 101 is adjusted in terms of perigee altitude 601, apogee altitude 602, and inertial position of the line of apsides 603, i.e., a line that is parallel to the major axis of the orbit.

As discussed above, a feature of a multi-functional vehicle 201 as disclosed herein is the ability thereof to reduce its exposed collection surface area by rotating 205 impact pads 204 such that they are perpendicular to the equatorial plane (e.g., such that their maximum surface area A is oriented in the nadir and anti-nadir directions). Thus, vehicles 201 can both fly in orbits that allow them to avoid non-targeted RSOs while also further reducing impact pad 204 area profiles as may be necessary or desirable. For instance, the software algorithms disclosed herein can compare the spatial and temporal equatorial crossings of all RSOs in the RSO catalog that are not to be collected. The software can then numerically test all orbits for possible collisions with RSOs that are to be avoided, allowing any needed orbital adjustments to be executed in a timely manner. In some cases where the desired RSO avoidance can be achieved by reducing impact pad area as seen by the RSO to be avoided, impact pads 204 can be rotated out of the equatorial plane as discussed above.

In addition to tuning orbits, the software algorithms disclosed herein can also use the collected sensor data to maintain a near-real-time complete spatial and temporal model of the “small but damaging” debris (e.g., from about 1 mm to about 10 cm in size) population throughout the LEO zone.

In summary, the software algorithms disclosed herein can create and maintain an environment in which large RSOs are avoided and small RSO collection is maximized. Furthermore, the software can further tune satellite constellation orbits to target small-but-dense-debris areas that threaten operating commercial and government satellites and constellations.

Although several embodiments have been described above with a certain degree of particularity, those skilled in the art could make numerous alterations to the disclosed embodiments without departing from the spirit or scope of this invention.

For example, sensor arrays 304 can also provide continuous SSA coverage of the geosynchronous Earth orbit (“GEO”) belt, offering low-latency surveillance of all spacecraft-sized objects in GEO. This enhances terrestrial GEO SSA and can resolve the “solar exclusive” problem that occurs during equinox periods.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of managing space traffic, comprising:
communicating with a satellite constellation including a plurality of satellites, each satellite being in a near-equatorial, low Earth orbit and comprising at least one sensor for tracking resident space objects (“RSO”):
wherein communicating with the satellite constellation further comprises:
receiving, from the satellite constellation, tracking data for a plurality of RSOs; and
using the tracking data received from the satellite constellation to adjust orbital trajectory information for the plurality of RSOs.

2. The method according to claim 1, further comprising integrating the tracking data received from the satellite constellation with an RSO catalog.

3. The method according to claim 2, wherein the RSO catalog comprises RSO tracking data received from a terrestrial sensor.

4. The method according to claim 1, further comprising issuing a conjunction warning between an RSO of the plurality of RSOs and a space vehicle based upon the adjusted orbital trajectory information for the plurality of RSOs.

5. The method according to claim 1, wherein communicating with the satellite constellation further comprises adjusting an orbit of at least one satellite responsive to the adjusted orbital trajectory information for the plurality of RSOs.

6. The method according to claim 5, wherein the at least one satellite comprises at least one debris interception vehicle, and adjusting an orbit of the at least one satellite responsive to the adjusted orbital trajectory information for the plurality of RSOs comprises commanding the at least one debris interception vehicle to maneuver into position to intercept a target RSO of the plurality of RSOs.

7. The method according to claim 1, wherein at least some satellites of the plurality of satellites comprise at least one debris impact pad.
